(19) United States
(12) Patent Application Publication
(10) Pub. No.: US 2021/0067635 A1
(43) Pub. Date: Mar. 4, 2021

(54) IMAGE PROCESSING APPARATUS AND METHOD FOR CONTROLLING IMAGE PROCESSING APPARATUS

(71) Applicant: TOSHIBA TEC KABUSHIKI KAISHA, Tokyo (JP)

(72) Inventor: Ryuuta IMAIZUMI, Mishima Shizuoka (JP)

(21) Appl. No.: 16/904,500

(22) Filed: Jun. 17, 2020

(30) Foreign Application Priority Data
Sep. 3, 2019 (JP) 2019-160668

(51) Int. Cl. H04N 1/00; H04N 1/32

(52) U.S. Cl. CPC H04N 1/00037; H04N 1/3263; H04N 1/00013; H04N 1/00042

(57) ABSTRACT

An image processing apparatus includes a printing unit configured to print an image on a sheet, a first sensor configured to detect a document in a reading unit, a second sensor configured to detect an error related to printing of the image by the printing unit, and a controller configured to generate a first screen for display presenting functions that can be executed by the image processing apparatus. The controller is further configured to, when the first sensor detects the document and the second sensor detects the error, generate a second screen for display indicating one or more first functions that require the reading unit but are not related to the printing of the image by the printing unit.

### CROSS-REFERENCE TO RELATED APPLICATIONS

This application is based upon and claims the benefit of priority from Japanese Patent Application No. 2019-160668, filed on Sep. 3, 2019, the entire contents of which are incorporated herein by reference.

### FIELD

Embodiments described herein relate generally to an image processing apparatus and a method for controlling the image processing apparatus.

### BACKGROUND

Conventional image forming apparatuses display a message indicating that an error has occurred (e.g., out of toner) even when the error affects functions (e.g., printing, fax, etc.) other than the function that the user wants to use (e.g., scanning). Therefore, in order to execute the desired function, the user needs to remedy the error or operate the operation panel to close the error message and open a screen for selecting the desired function, which may take additional time and thus waste man-hours.

### BRIEF DESCRIPTION OF THE DRAWINGS

FIG. 1 is a cross-sectional view of an image forming apparatus according to an embodiment.

FIG. 2 is a functional block diagram of an image forming apparatus according to an embodiment.

FIG. 3 is a perspective view of a cover on a reading surface of an image forming apparatus according to an embodiment.

FIG. 4 is an example of a first screen displayed by an image forming apparatus of an embodiment.

FIG. 5 shows an example of a third screen displayed by an image forming apparatus of an embodiment.

FIG. 6 shows an example of a second screen displayed by an image forming apparatus when a plurality of functions are available as second functions.

FIG. 7 shows an example of a second screen when only a single function is available as a second function.

FIG. 8 is a flowchart of a process executed by an image forming apparatus according to an embodiment.

FIGS. 9-11 depict display variations of the second screen and the third screen.

### DETAILED DESCRIPTION

In one embodiment, an image processing apparatus includes a printing unit configured to print an image on a sheet, a first sensor configured to detect a document in a reading unit, a second sensor configured to detect an error related to printing of the image by the printing unit, and a controller configured to generate a first screen for display. The first screen presents a plurality of functions that can be executed by the image processing apparatus. The controller is further configured to generate a second screen for display if the first sensor detects the document and the second sensor detects the error. The second screen indicates one or more first functions that require the reading unit but are not related to the printing of the image by the printing unit.

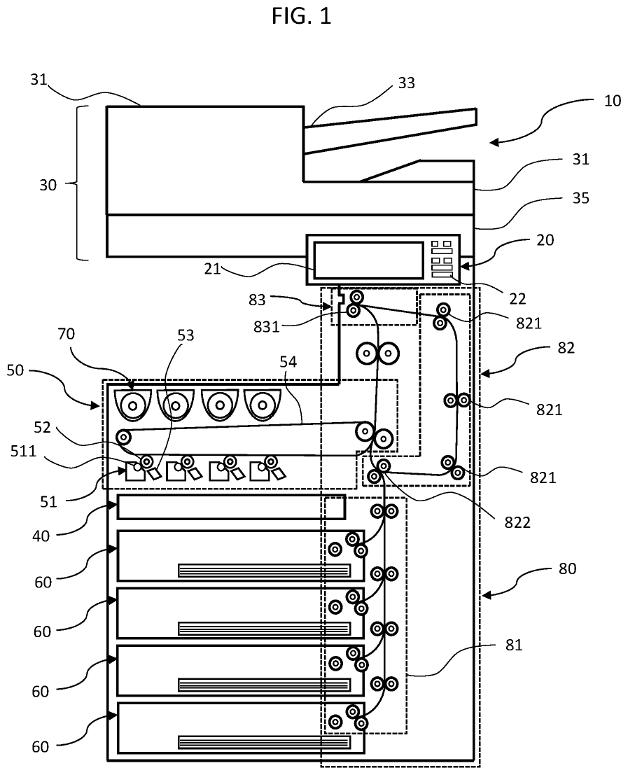

The image forming apparatus 10 according to an embodiment will be described with reference to FIGS. 1 to 3. FIG. 1 is a cross-sectional view of an image forming apparatus 10. The depicted view in FIG. 1 can be considered to be from a first (or front) side of the image forming apparatus 10. The image forming apparatus 10 is, for example, an MFP (Multi Function Peripheral). The image forming apparatus 10 includes an operation unit 20, a reading unit 30, an optical unit 40, a printing unit 50, a sheet feeding cassette 60, a toner cartridge 70, and a sheet conveying unit 80.

The operation unit 20 includes a screen 21 and one or more operation keys 22 on the front of the image forming apparatus 10. For example, the screen 21 is a touch panel display for displaying contents and accepting operation inputs from the user. Similarly to the screen 21, the operation keys 22 also accept operation inputs from the user. In some contexts, the operation unit 20 may be referred to as an input panel, a user input panel, an operator panel, or the like.

The reading unit 30 is a part of the image forming apparatus 10. The reading unit 30 shines light on a document, and converts the reflected light into an electric signal. For example, when a copy function is executed, the converted electric signal is sent to the optical unit 40. Further, for example, when a scan function is executed, the electric signal is stored as electronic image data in a specified or predetermined storage location. In the course of these processes, image processing such as image correction, image processing, and/or image editing may be performed.

The optical unit 40 includes a LSU (Laser Scanning Unit) configured to convert an image signal received from an external terminal or the reading unit 30 into light which is then used to irradiate the surface of a photosensitive drum to thereby form a latent image on surface of the photosensitive drum 52.

The printing unit 50 includes a developing device 51, the photoreceptor drum 52, a charger 53, a transfer belt 54, a toner cartridge 70, and the like.

The toner cartridge 70 stores toner and the developing device 51 is replenished with the toner from the toner cartridge 70. The toner is mixed in the developing device 51 with a metallic powder, which is a carrier, and adheres to the metal powder.

The developing device 51 includes a magnet roller 511. The magnet roller 511 attracts and then rotates the metal powder to which the toner is attached.

The surface of the photoreceptor drum 52 is electrically charged by the charger 53, and the photoreceptor drum 52 is then exposed by the optical unit 40 as described above, thereby form a latent image on the surface of the photoreceptor drum 52. The toner adhering to the metallic powder is electrostatically attracted to the charged portions of the latent image formed on the surface of the photoreceptor drum 52, and thereby forms a toner image thereon. The toner image on the photoreceptor drum 52 is eventually transferred to a sheet conveyed by the sheet conveying unit 80 via the transfer belt 54. Then, heat and pressure are applied by the fixing device to the sheet with the toner image thereon, thereby fixing the toner image to the sheet. It is also possible in some examples to transfer the toner image directly from the photoreceptor drum 52 to a sheet without using a transfer belt 54.

The sheet feeding cassette 60 stores sheets of paper used for printing. The sheet feeding cassette 60 includes a switch or other sensor to detect whether or not a sheet is present in the sheet feeding cassette 60.

As depicted in FIG. 1, the sheet conveying unit 80 is divided into three portions: a sheet feeding portion 81, a conveying portion 82, and a sheet discharge portion 83. The sheet feeding portion 81 separates the sheets stacked in sheet feeding cassette 60 for conveying a single sheet at a time. The conveying portion 82 includes a plurality of conveying rollers 821, a registration roller 822, and the like. The conveying roller 821 conveys the sheets one by one. The registration roller 822 temporarily stops a sheet to be conveyed, and then sends out the sheet to the transfer belt 54 at an appropriate timing. The sheet discharge portion 83 includes a sheet discharge roller 831 and the like. The sheet discharging roller 831 discharges printed sheets from the main body of the image forming apparatus 10 after conveyance on the conveying portion 82.

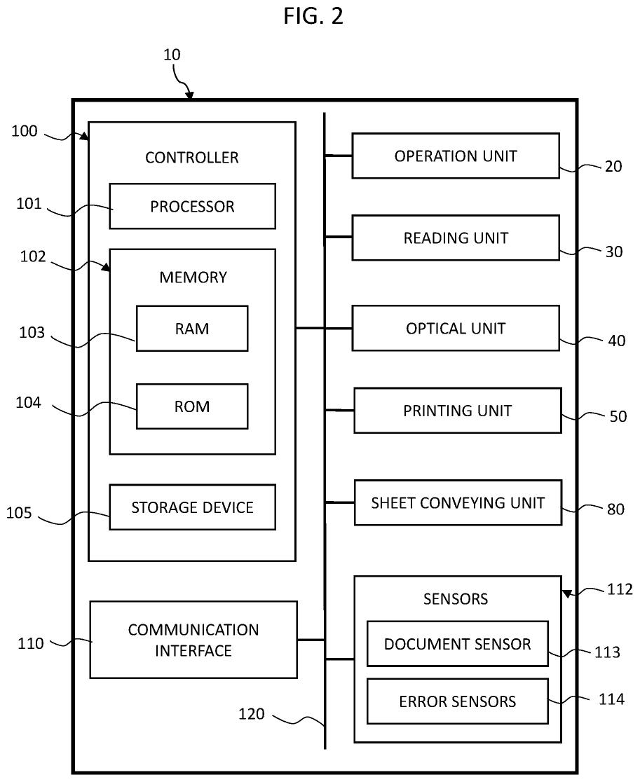

Next, the controller 100 will be described with reference to FIG. 2. FIG. 2 is a functional block diagram of the image forming apparatus 10 according to the present embodiment.

In the image forming apparatus 10, the operation unit 20, the reading unit 30, the optical unit 40, the printing unit 50, the sheet conveying unit 80, a controller 100, a communication interface 110, and any sensors 112 are connected to each other via a bus 120.

The controller 100 includes a processor 101, a memory 102, and a storage device 105. The processor 101 is a CPU (Central Processing Unit), and is hardware for executing instruction sets described in software programs. The memory 102 includes a RAM (Random Access Memory) 103 which is a volatile memory area for loading programs and related data, and a Read Only Memory (ROM) 104 which is a non-volatile memory for storing control programs. The storage device 105 stores data and programs.

The communication interface unit 110 is an interface for connecting to an external terminal such as a personal computer (PC) or a print server via a network.

The sensors 112 includes a document sensor 113 and one or more error sensors 114. The sensors 112, for example, detect the presence or absence of a document or paper in the sheet feeding cassette 60 and also the magnetic permeability of the toner and carrier in the developing device 51.

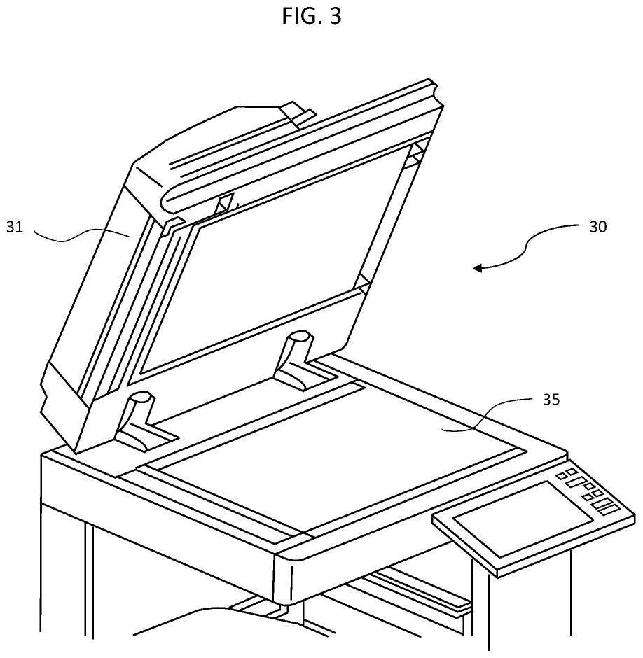

Next, the reading unit 30 and the document sensor 113 will be described with reference to FIG. 3. FIG. 3 is a perspective view of the image forming apparatus 10 in a state in which the document cover of the reading unit 30 is opened.

An ADF 31 (Auto Document Feeder) is provided in the document cover of the reading unit 30. The document cover including the ADF 31 rotates on hinges or the like to cover the reading surface 35 of the reading unit 30.

The document sensor 113 is a sensor for detecting whether a document is in the reading unit 30. In this context, a document sensor 113 of the reading unit 30 includes a sensor for the ADF 31 and a sensor for the reading surface 35. For example, a switch is provided on the ADF 31 to detect a document set on the document feed tray 33 (see FIG. 1). An optical sensor can be provided under the reading surface 35 to detect a document that has been placed on the reading surface 35. For example, the switch and the optical sensor are configured to detect the document when the document cover 31 has been closed.

Next, the error sensors 114 for detecting errors in the image forming apparatus 10 will be described. Here, in this context, an error refers to something which prevents image formation on a paper sheet. For example, an error may be a paper jam, a lack of paper in the sheet feed cassette 60 (sheet empty detected), and exhaustion of the toner in a toner cartridge 70 (toner empty detected).

(Paper Jam)

For example, the error sensors 114 include a plurality of sensors installed along the conveying path through which a sheet is conveyed. For example, each of these sensors is an optical element or a switch configured to detect the presence of the sheet at different positions on the path. When the at least one sensor detects the paper sheet has stopped on the path, it is determined that the paper sheet is jammed.

(Sheet Empty)

For example, the error sensors 114 include a sensor or a mechanical switch installed in the sheet feeding cassette 60 to detect a sheet located at a predetermined position. Therefore, when the sheet is not present at the predetermined position, it can be determined that the sheet feeding cassette 60 is empty.

(Toner Empty)

The developing device 51 of the printing unit 50 is replenished with toner from the toner cartridge 70, and the toner is stirred in the developing device 51 together with a metal powder which is a carrier. The error sensors 114 include a sensor installed in the developing device 51 to detect the magnetic permeability of the toner and the carrier being stirred. The controller 100 controls the amount of toner supplied to the developing device 51 so as to maintain a predetermined magnetic permeability. That is, when the amount of toner in the developing device 51 is reduced and the magnetic permeability is reduced, the controller 100 executes a toner supply operation. However, when no toner remains in the toner cartridge 70, the toner cannot be supplied to the developing device 51 even when the toner supply operation is performed. As a result, the magnetic permeability is not maintained. In this manner, when the magnetic permeability does not exceed a threshold even though the toner supply operation has been executed, it can be determined that the toner is empty.

The error detection methods described above are non-limiting examples, and any other known technique may be used to detect the aforementioned errors.

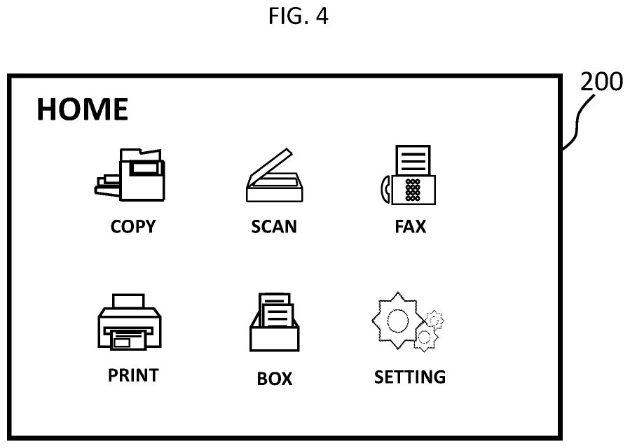

Next, examples of screens displayed by the image forming apparatus 10 will be described with reference to FIGS. 4 to 7. FIG. 4 shows an example of a first screen 200 according to the present embodiment. In the normal case, when the image forming apparatus 10 is turned on or the image forming apparatus 10 wakes up from the standby state, a first screen 200 (also called a home screen in some instances) is displayed on the screen 21.

Here, a plurality of selectable icons, such as “copy”, “scan”, “FAX”, “print”, “box”, and “setting,” are displayed on the screen as executable functions.

The copy is a function of forming an image that has been read from a document by the reading unit 30 on a sheet. The print is a function of forming an image that has been acquired from an external terminal on a sheet. The scan is a function of reading a document from the reading unit 30 and generating electronic image data. The FAX is a function of transmitting an image that has been acquired from a document by the reading unit 30 or an external terminal to an external device connected via a communication line, or receiving an image from an external device via the communication line. The setting is a function for changing settings of the image forming apparatus. For example, the settings include a display language setting, a color mode selection, and a resolution mode selection for printing and scanning. The “BOX” function is a function for storing an image, as acquired from an original document or an external terminal, in the storage device 105 of the image forming apparatus 10, and printing the stored image. For example, an image that has been printed before and stored using the BOX function can later be quickly printed again using the BOX function.

In the following description, functions that require reading or scanning a document are referred to as first functions. That is, the first functions in this embodiment include the “copy”, “scan”, and “FAX” functions displayed in the first screen 200.

Furthermore, from among these first functions, functions which can be executed even if a particular error is detected by the error sensors 114 are regarded as second functions. For example, when the “copy” function cannot be executed due to a detected error, and the second functions include the “scan” and “FAX” functions displayed in the first screen 200.

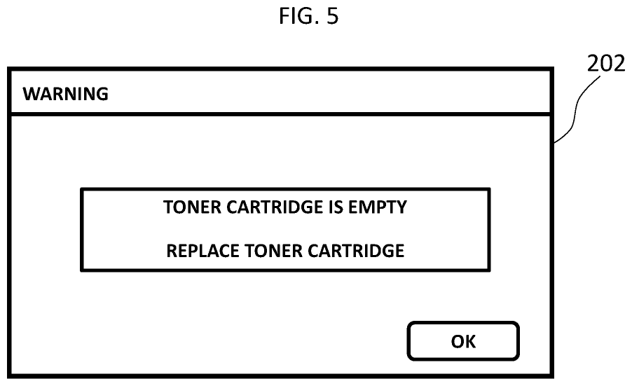

FIG. 5 shows an example of an error screen (hereinafter called the third screen 202). For example, the third screen 202 is displayed when the error sensors 114 detect an error. More specifically, the third screen 202 indicating that “Toner cartridge is empty” shows up when a document is set in the reading unit 30 and the “copy” function is selected but the error sensors 114 detect an error of toner empty. Further, as shown in FIG. 5, a guidance to solve the error, “Replace toner cartridge” may be displayed. This error screen disappears when the user presses the “OK” button displayed in the same screen or eliminates the error itself.

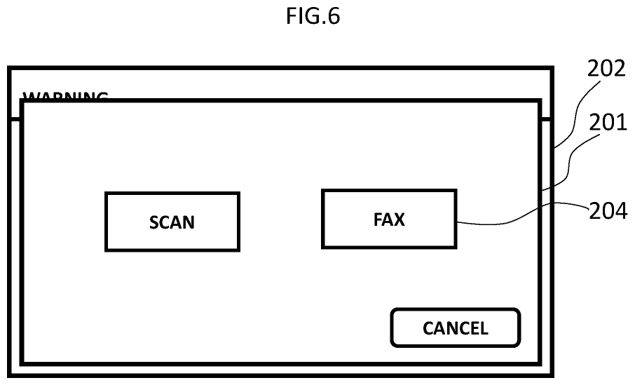

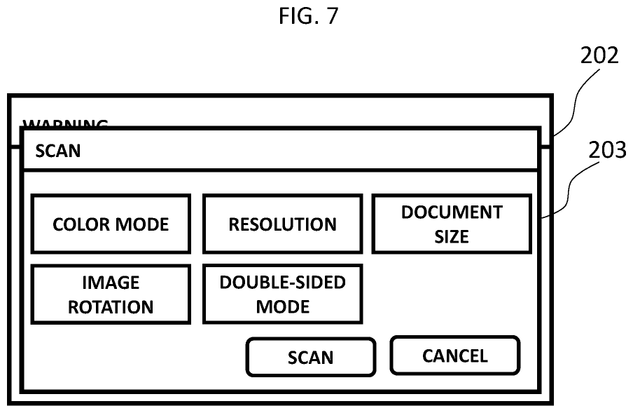

FIG. 6 shows an example of a screen in a case where a plurality of second functions, e.g., “scan” and “FAX,” are displayed in the second screen 201 of the present embodiment. Here, the screen is displayed when the user sets a document in the reading unit 30 and the error sensors 114 detect an error that affects the print function. In this case, since the document is set in the reading unit 30, the user is highly likely to use one of the first functions that require reading the document. On the other hand, since the error sensors 114 detect the error related to the print function, the print function is not executable. Thus, the second screen 201 only shows buttons 204 for executing the second functions, e.g., “scan” and “FAX,” on the screen 21. For example, as shown in FIG. 6, “scan” and “FAX” are displayed on the second screen 201, and can thus be selected by the user. When the user presses one of the “scan” button and the “FAX” button, the screen 21 transitions to a function setting screen 203 shown in FIG. 7. The second screen 201 is closed when the user presses the “cancel” button.

FIG. 7 shows an example of the function setting screen 203 for setting one of the functions. In this example, the function setting screen 203 shows settings for the scanning function, i.e., “color mode”, “resolution”, “document size”, “image rotation”, and “double-sided mode.” In one embodiment, the function setting screen 203 for the scanning function is automatically displayed when (i) the document is set in the reading unit 30, (ii) the error sensors 114 detects an error that affects the printing function (e.g., toner empty), and (iii) the FAX function is not available. In other words, since the only available second function is the “scan” function, it is not necessary to display the second screen 201 for selecting the functions as shown in FIG. 6. By directly making a transition to the scan function setting screen 203 (shown in FIG. 7), it is possible to omit the selection step by the user.

For example, an error that affects the FAX function is detected when a connection to an external apparatus via the communication interface 110 cannot be established.

The third screen 202 shown in FIG. 5 is an error screen for indicating a corresponding error message when at least one of the error sensors 114 detect an error in the image forming apparatus 10. The second screen 201 may be displayed together with the third screen 202. For example, the second screen 201 can be overlaid on third screen 202 as a pop-up screen so that the user can see a part of the third screen 202. By displaying in this manner, the user can recognize that an error has occurred in the image forming apparatus 10, and then can execute the desired function.

However, the display method of the screen is not limited to the examples described above. For example, when the second screen 201 is displayed, the third screen 202 may be closed.

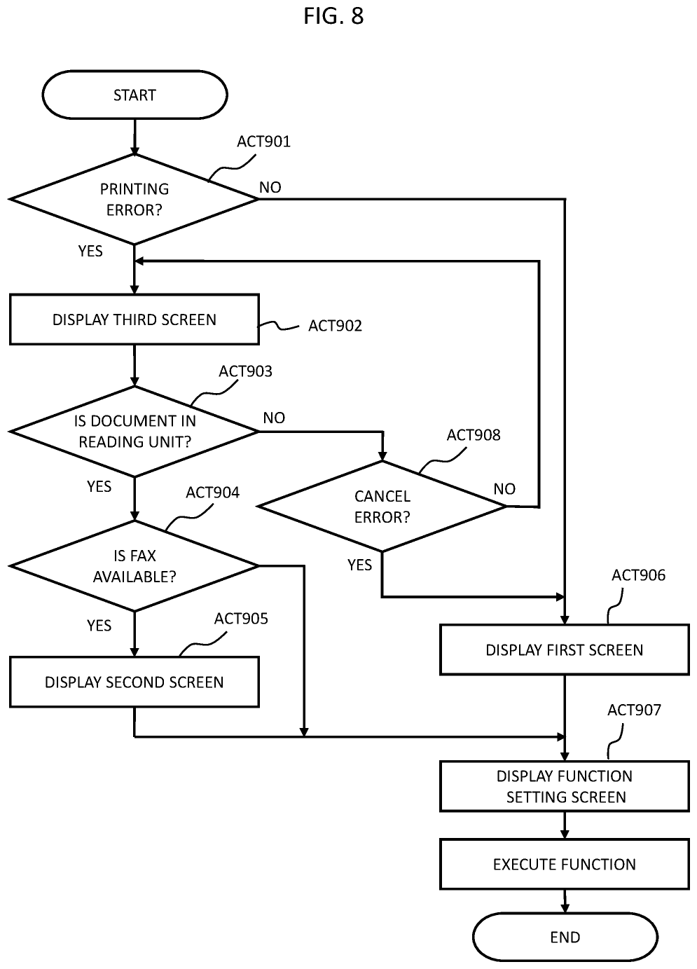

Next, the control of the screen transition shown in FIG. 5 to FIG. 7 will be described with reference to FIG. 8. FIG. 8 is a flowchart of a process performed by the controller 100 of the image forming apparatus 10. Here, a description will be given on the assumption that the image forming apparatus 10 is powered on.

First, the controller 100 determines whether or not the error sensors 114 detect an error in the printing function (ACT 901). When the controller 100 determines that the error sensors 114 detect an error (ACT 901, YES), the controller 100 generates the third screen 202 to be displayed on the screen 21, indicating that the print function is not available (ACT 902). Thereafter, the controller 100 determines whether or not the document sensor 113 detects a document in the reading unit 30 (ACT 903). When the controller 100 determines that the document sensor 113 detects a document in the reading unit 30 (ACT 903, YES), the controller 100 determines whether or not the FAX function is available. If the FAX function is available (ACT 904, YES), the controller 100 generates the second screen 201 to be displayed on the screen 21, including the function keys 204 corresponding to the second functions, e.g., the scan and FAX functions (ACT 905). When one of the function keys 204 is selected by the user in the second screen 201, the controller 100 generates the function setting screen 203 corresponding to the selected function, to be displayed on the screen 21 (ACT 907). After that, when the execution key is selected by the user, the controller 100 executes the corresponding function (ACT 910). For example, in the function setting screen 203 of the scan function shown in FIG. 7, the scan function is executed by selecting the “scan” button by the user. On the other hand, in ACT 904, when the controller determines that the FAX function is not available (ACT 904, NO), the controller 100 generates the third screen 203 for the scan function, to be displayed on the screen 21 (ACT 907).

In ACT 901, when the controller determines that the error sensors 114 do not detect an error in the print function (ACT 901, NO), the controller 100 generates the first screen 200 to be displayed on the screen 21 (ACT 906). When one of the plurality of displayed functions is selected by the user in the first screen 200, the controller 100 generates the corresponding function setting screen 203 to be displayed on the screen 21 (ACT 907).

In ACT 903, when the controller determines that the document sensor 113 of the reading unit 30 does not detect the document (ACT 903, NO), and when the error itself is eliminated by the user, or the third screen 202 displayed in ACT 902 is closed by the user, the controller 100 generates the first screen 200 to be displayed on the screen 21 (ACT 908, YES). If the error is not eliminated and the third screen 202 is not closed, the third screen 202 continues to be displayed (ACT 908, NO).

According to the present embodiment, when an error occurs in the image forming apparatus 10, the number of steps required to perform a desired function can be reduced compared to the conventional method. For example, the functions that require reading of a document in the present embodiment are the copy, scan, and FAX functions. In the conventional operation process, when the scan function is to be used, but an error occurs related to the printing function, the following five steps are required to be performed by the user: setting a document in the reading unit 30, confirming the unavailability of printing function in the error screen 202, selecting the scanning function in the first screen 200, setting parameters for the scan function, and executing the scan function. In contrast, in the present embodiment, the following four steps are required: setting a document in the reading unit 30, selecting the scanning function from among the functions displayed in the second screen 201, setting parameters for the scanning function, and executing the scanning function. Furthermore, in the case where both the printing and FAX functions are not available, only the following three steps are required: setting a document in the reading unit, setting parameters for the scanning function, which is the only presently available second function, in the function setting screen 203, and executing the scanning function. Therefore, the user steps required to perform a desired function may be reduced.

Further, as compared with the conventional method of selecting a function from the first screen 200, since the functions displayed on the screen are limited to the executable functions in this embodiment, information unnecessary for the user can be eliminated from the screen.

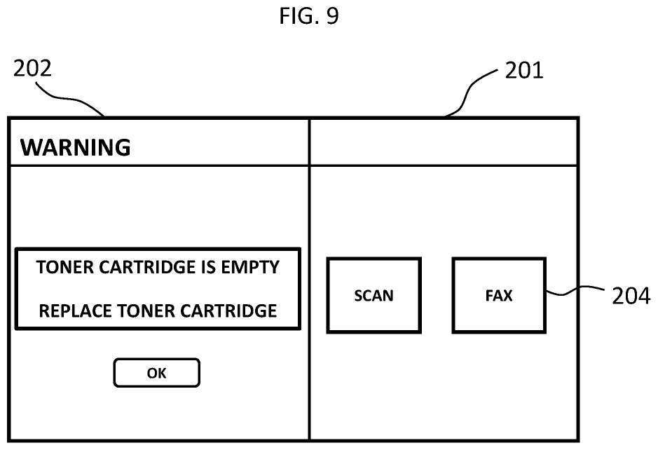

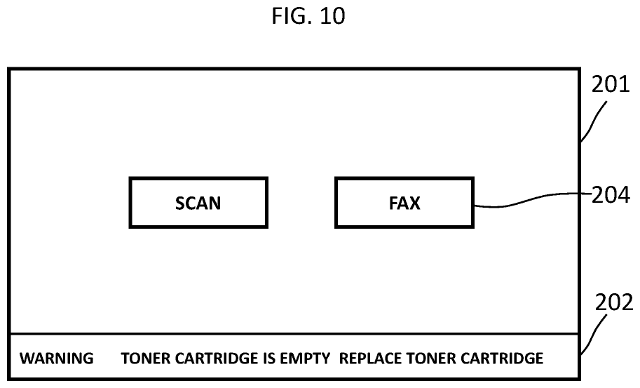

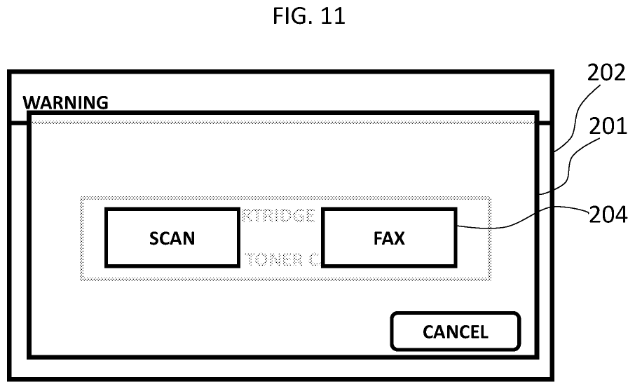

FIGS. 9 to 11 depict modification examples of the second screen 201 and the third screen 202. For example, the screen 21 may be divided into left and right portions (FIG. 9) or upper and lower portions (FIG. 10) so that the contents of both of the second screen 201 and the third screen 202 are displayed at once. Also, as shown in FIG. 11, a transparent or semi-transparent second screen 201 can be displayed over the third screen 202 so that the user can still see the content of the third screen 202.

Each of the function keys 204 shown in the second screen may be an icon, a text character (or text characters), or the like, which when selected cause transition to the function setting screen 203 of the corresponding function as selected by the user.

Moreover, the above embodiments are applicable to the functions that might be added by optional or extension units for the image forming apparatus 10, so long as such optional or extension units are capable of reporting errors to the controller 100 of the image forming apparatus 10 when functions provided by such optional or extension units are unavailable due to an error or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. An image processing apparatus, comprising:
a printing unit configured to print an image on a sheet;
a first sensor configured to detect a document in a reading unit;
a second sensor configured to detect an error related to the printing unit;
a controller configured to generate:
a first screen for display, the first screen presenting a plurality of functions that can be executed by the image processing apparatus, and
a second screen for display when the first sensor detects the document and the second sensor detects the error, the second screen presenting one or more first functions that require the reading unit but not the printing unit.

2. The image processing apparatus according to claim 1, wherein when there is only one first function that requires the reading unit but not the printing unit, the controller generates the second screen to show settings for said only one first function.

3. The image processing apparatus according to claim 1, wherein when there are two or more first functions that require the reading unit but not related the printing unit, the controller generates the second screen to show two or more selectable objects corresponding to said two or more first functions.

4. The image processing apparatus according to claim 3, wherein the controller is further configured to, upon selection of one of the selectable objects, generate a third screen for display showing settings for a first function corresponding to the selected object.

5. The image processing apparatus according to claim 1, wherein the controller is further configured to generate an error screen for display indicating the error detected by the second sensor.

6. The image processing apparatus according to claim 5, wherein the second and error screens are displayed to be horizontally adjacent.

7. The image processing apparatus according to claim 5, wherein the second and error screens are displayed to be vertically adjacent.

8. The image processing apparatus according to claim 5, wherein the second screen is displayed to be overlaid on the error screen.

9. The image processing apparatus according to claim 1, wherein the second sensor is configured to detect a sheet jammed on a sheet conveyance path in the image processing apparatus.

10. The image processing apparatus according to claim 1, wherein the second sensor is configured to detect toner stored in a developing device of the image processing apparatus.

11. A method for controlling an image processing apparatus, the method comprising:
displaying a first screen presenting a plurality of functions that can be executed by the image processing apparatus;
detecting, by a first sensor, a document in a reading unit of the image processing unit;
detecting, by a second sensor, an error related to printing of an image by a printing unit of the image processing apparatus; and
when the document is detected in the reading unit and the error is detected, displaying a second screen indicating one or more first functions that require the reading unit but not the printing unit.

12. The method according to claim 11, wherein when there is only one first function that requires the reading unit but not the printing unit, the second screen shows settings for said one first function.

13. The method according to claim 11, wherein when there are two or more first functions that require the reading unit but are not the printing unit, the second screen shows two or more selectable objects corresponding to said two or more first functions.

14. The method according to claim 13, further comprising:
upon a selection of one of the selectable objects, displaying a third screen showing settings for a first function corresponding to the selected object.

15. The method according to claim 11, further comprising:
displaying an error screen indicating the error detected by the second sensor.

16. The method according to claim 15, wherein the second and error screens are horizontally adjacent on a display.

17. The method according to claim 15, wherein the second and error screens are vertically adjacent on a display.

18. The method according to claim 15, wherein the second screen is displayed over the error screen.

19. The method according to claim 11, wherein detecting the error includes detecting a sheet jammed on a sheet conveyance path in the image processing apparatus.

20. The method according to claim 11, wherein detecting the error further includes detecting toner stored in a developing device of the image processing apparatus.
